(19) United States
(12) Patent Application Publication
(10) Pub. No.: US 2013/0242136 A1
(43) Pub. Date: Sep. 19, 2013

(54) ELECTRONIC DEVICE AND GUIDING METHOD FOR TAKING SELF PORTRAIT

(71) Applicant: FIH (HONG KONG) LIMITED, Kowloon (HK)

(72) Inventor: CHIH-CHIEN CHEN, New Taipei (TW)

(73) Assignee: FIH (HONG KONG) LIMITED, Kowloon (HK)

(21) Appl. No.: 13/743,363

(22) Filed: Jan. 17, 2013

(30) Foreign Application Priority Data
Mar. 15, 2012 (TW) 101108906

(51) Int. Cl. H04N 5/232

(52) U.S. Cl. CPC H04N 5/23219
USPC 348/231.99; 348/222.1

(57) ABSTRACT

In a guiding method for taking self portrait using an electronic device, a coordinate system is constructed based on an image preview interface provided by a camera module of the electronic device. The method presets a target region, and recognizes a face region on the image preview interface. The method further outputs first prompt information to prompt that a self portrait is ready to be captured when the face region is located in the target region, or outputs second prompt information to prompt that the electronic device needs to be moved when the face region is not located in the target region.

### BACKGROUND

1. Technical Field

Embodiments of the present disclosure relate to image capturing technology, and particularly to an electronic device and guiding method for taking a self portrait using the electronic device.

2. Description of Related Art

Many electronic devices have camera modules for capturing images. For example, an electronic device may have a rear-facing camera and/or a front-facing camera. The front-facing camera may be used to take a self portrait and the user may preview the self portrait before capturing. However, many front-facing cameras are not high resolution cameras. Generally, the rear-facing camera has higher resolution than the front-facing camera. But the user cannot preview the image in real time before capturing by the rear-facing camera. Therefore, an efficient method to overcome this shortcoming is desired.

### BRIEF DESCRIPTION OF THE DRAWINGS

FIG. 1 is a schematic diagram of one embodiment of an electronic device including a guiding system.

FIG. 2 is a schematic diagram of function modules of the guiding system in the electronic device.

FIGS. 3A, 3B, 3C, and 3D are schematic diagrams of a image preview interface provided by the guiding system.

FIG. 4 is a flowchart of one embodiment of a method for presetting parameters using the guiding system.

FIG. 5 is a flowchart of a guiding method for taking a self portrait using the guiding system in the electronic device.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

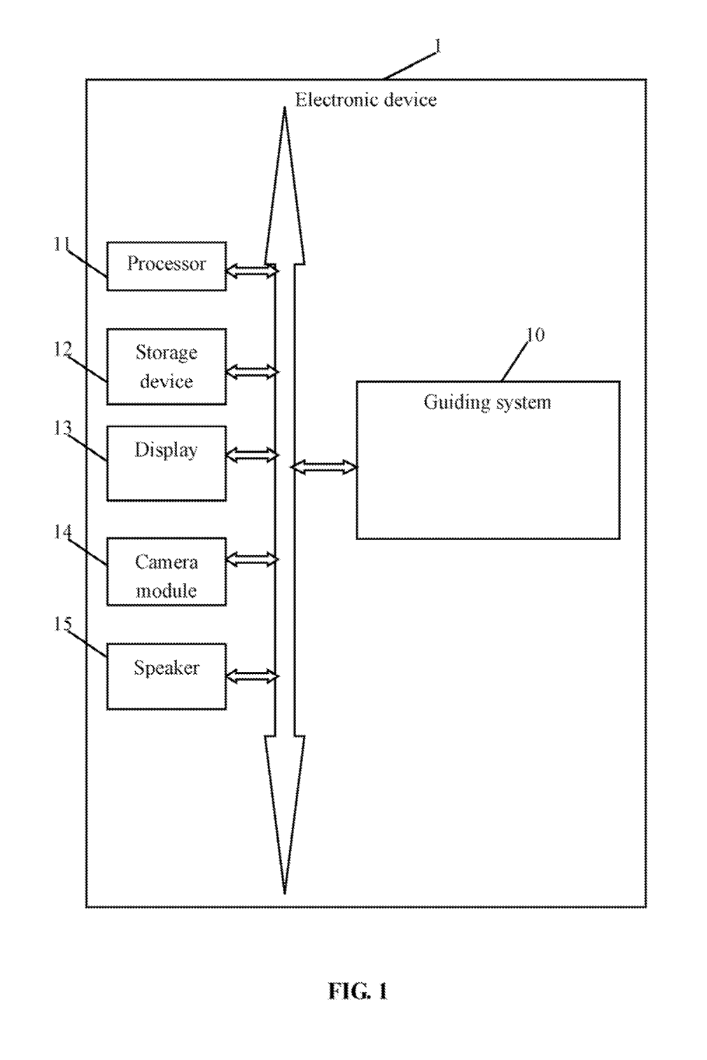

FIG. 1 is a block diagram of one embodiment of an electronic device 1 including a guiding system 10. The electronic device 1 further includes at least one processor 11, a storage device 12, a display 13, a camera module 14, and a speaker 15. It should be understood that FIG. 1 illustrates only one example of the electronic device 1 that may include more or fewer components than illustrated, or a different configuration of the various components in other embodiments.

The guiding system 10 is used to prompt a user of the electronic device 1 to move a position of the electronic device 1, to capture an image that accords with predetermined requirements, when the user controls the camera module 14 of the electronic device 1 to take a self portrait. A detailed description of the guiding system 10 will be given in the following paragraphs.

In one embodiment, the electronic device 1 may be a mobile phone, a tablet personal computer, a personal digital assistant, or any other device. In one embodiment, the storage device 12 provides one or more memory functions. In one embodiment, guiding system 10 may include computerized instructions in the form of one or more programs that are executed by the at least one processor 11 and stored in the storage device 12. The storage device 12 stores one or more programs, such as the operating system, other applications of the electronic device 1, and various kinds of data, such as images. In some embodiments, the storage device 12 may include a memory of the electronic device 1 and/or an external storage card, such as a memory stick, a smart media card, a compact flash card, a secure digital card, or any other type of memory storage device.

The display device 13 may be a liquid crystal display (LCD) or a touch-sensitive display (a capacitive touch panel), for example. The camera module 14 may be used to capture images, such as self portrait, for example. In some embodiments, the camera module 14 (e.g., a camera) may include an image sensor, a lens, and other components. The speaker 15 may be used to output audible data, such as music, or predetermined prompt information, for example.

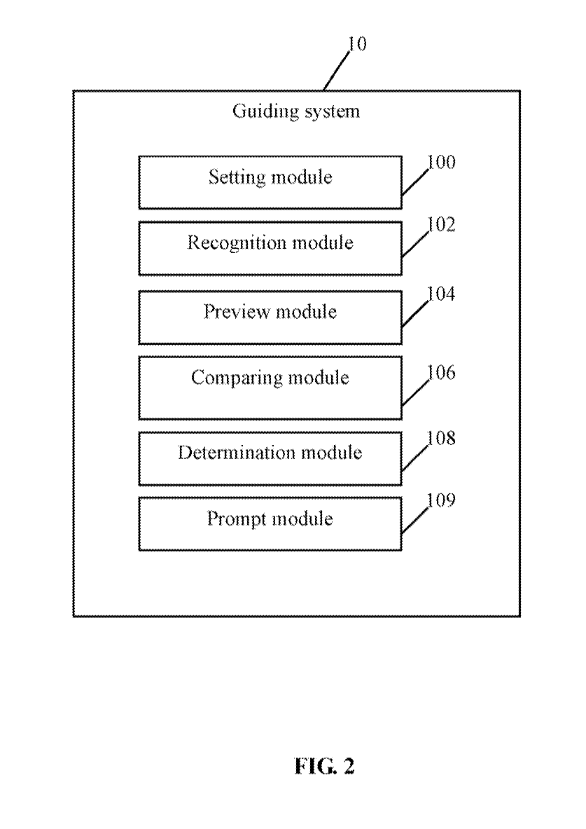

FIG. 2 is a block diagram of function modules of the guiding system 10 included in the electronic device 1. In one embodiment, the guiding system 10 may include one or more modules, for example, a setting module 100, a recognition module 102, a preview module 104, a comparing module 106, a determination module 108, and a prompt module 109. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

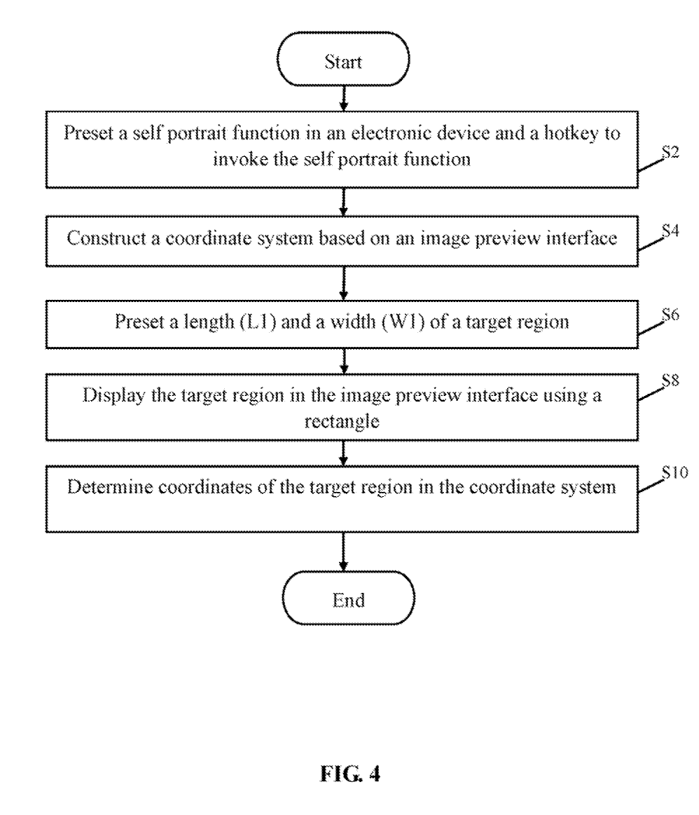

FIG. 4 is a flowchart of one embodiment of a method for presetting parameters using the guiding system 10. In some embodiments, before using the guiding system 10 to implement the guiding method for taking a self portrait, a plurality of parameters need to be preset. Depending on the embodiment, additional steps may be added, others removed, and the ordering of the steps may be changed.

In step S2, the setting module 100 presets a self portrait function in the electronic device 1, and presets a hotkey to invoke the self portrait function. The setting module 100 may prompt the user whether to invoke the self portrait function when the camera module 14 is activated. The hotkey may be a physical keystroke, or a virtual keystroke.

In step S4, the setting module 100 constructs a coordinate system based on an image preview interface provided by the camera module 14.

In step S6, the setting module 100 sets a target region on the image preview interface, and presets a length and a width of the target region. The target region is used to determine whether a face of the user is at a predetermined position on the image preview interface. In some embodiments, the target region is represented using a rectangle displayed on the image preview interface.

In step S8, the setting module 100 displays the target region using a rectangle on the image preview interface.

In step S10, the setting module 100 determines a position of the target region, and determines coordinates of the target region at the position.

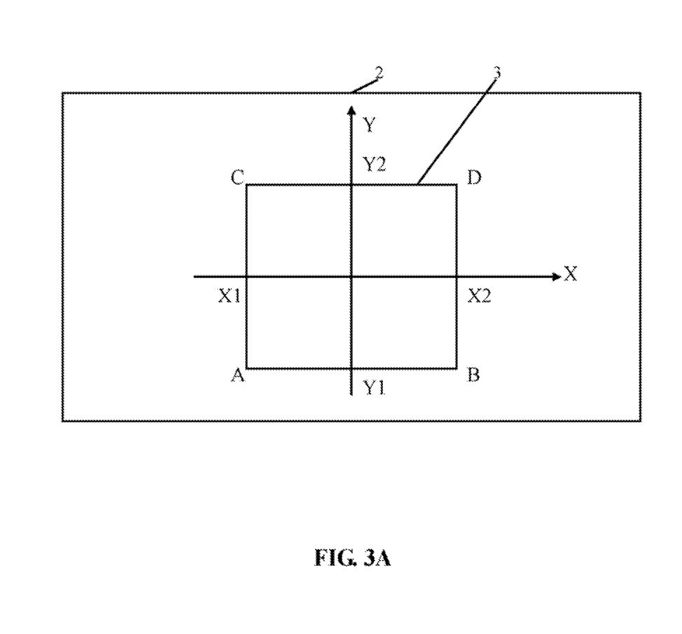

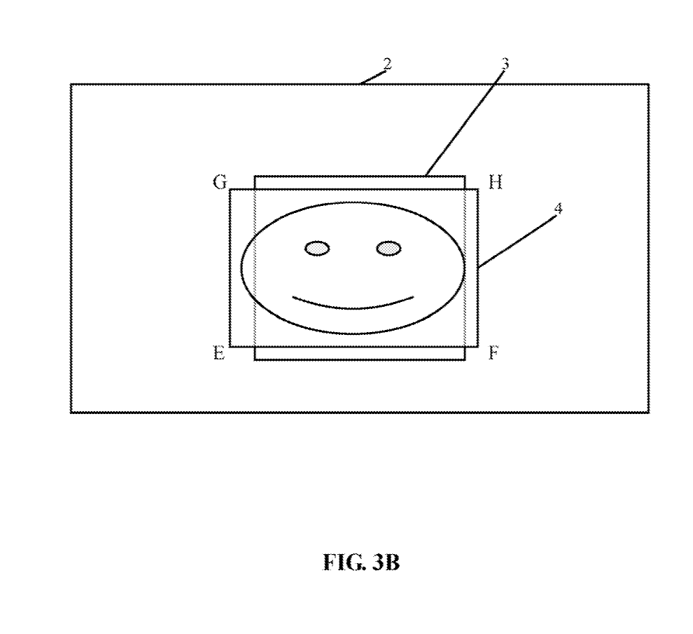

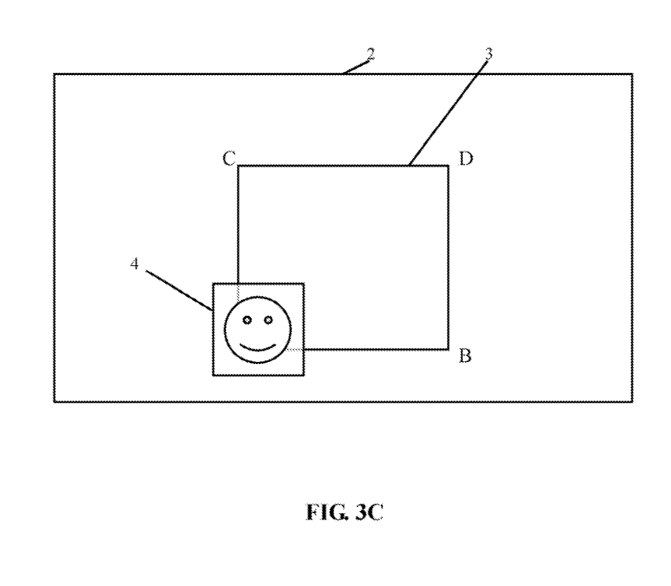

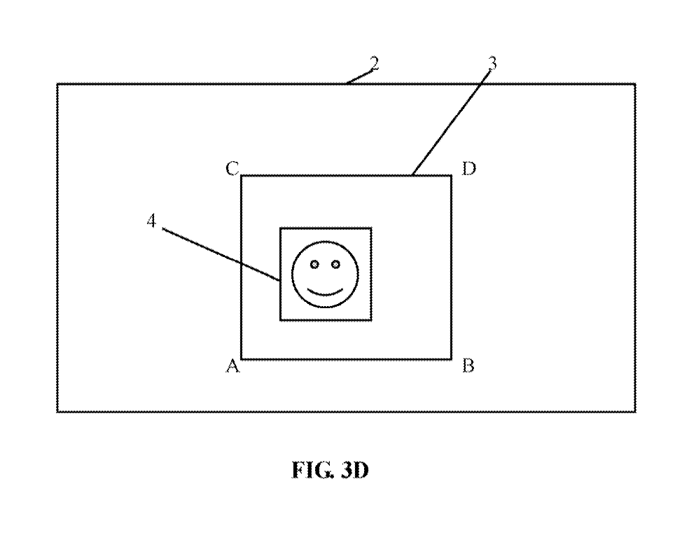

In some embodiments, as shown in FIG. 3A, the display 13 displays the image preview interface provided by the camera module 14. When the camera module 14 is activated, the user may preview a scene to be captured through the image preview interface. The target region is displayed as the rectangle on the image preview interface. The length, the width, and a position of the target region may be changed according to user requirements. FIG. 3A merely shows an example of the image preview interface and the target region.

FIG. 3A shows that an image preview interface 2 includes a target region 3 having four vertexes A, B, C, and D. In the coordinate system, coordinates of the four vertexes are: A (X1, Y1), B (X2, Y1), C (X1, Y2), and D (X2, Y2). The length (L1) of the target region 3 is a difference between X2 and X1, for example, L1=X2−X1. The width (W1) of the target region 3 is a difference between Y2 and Y1, for example, W1=Y2−Y1. In other embodiments, the coordinate system may be constructed according to other requirements.

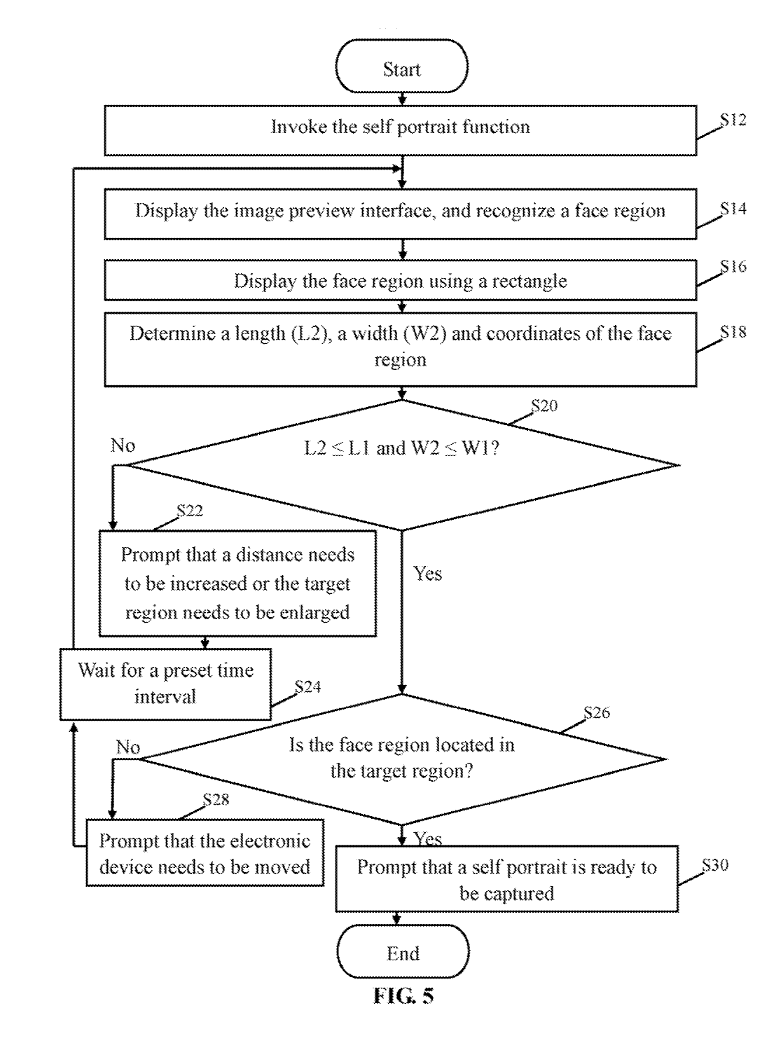

FIG. 5 is a flowchart of one embodiment of a guiding method for taking a self portrait using the guiding system 10 in the electronic device 1. Depending on the embodiment, additional steps may be added, others removed, and the ordering of the steps may be changed.

In step S12, the self portrait function is invoked using the preset hotkey when the camera module 14 is activated.

In step S14, the setting module 100 displays the image preview interface on the display 13, and the recognition module 102 recognizes a face region on the image preview interface. In some embodiments, the recognition module 102 may recognize the face region using known technologies.

In step S16, the recognition module 102 displays the face region using a rectangle on the image preview interface.

In step S18, the preview module 104 determines a length, a width and coordinates of the face region. As shown in FIG. 3B, a face region 4 has four vertexes E, F, G and H. In the coordinate system, coordinates of the four vertexes are: E (X3, Y3), F (X4, Y3), G (X3, Y4), and H (X4, Y4). The length (L2) of the face region 4 is a difference between X4 and X3, for example, L2_X4−X3. The width (W2) of the face region 4 is a difference between Y4 and Y3, for example, W2=Y4−Y3.

In step S20, the comparing module 106 determines whether the length of the face region is not more than the length of the target region, and whether the width of the face region is not more than the width of the target region, by comparing the length and the width of the face region with the length and the width of the target region.

If the length of the face region is more than the length of the target region, and/or the width of the face region is more than the width of the target region, the procedure goes to step S22. Otherwise, if the length of the face region is not more than the length of the target region, and the width of the face region is not more than the width of the target region, the procedure goes to step S26.

In step S22, the prompt module 109 determines that the face region exceeds the target region, and outputs third prompt information to prompt that a distance between a user and the electronic device needs to be increased or the target region needs to be enlarged.

As shown in FIG. 3B, the length of the face region 4 has exceeded the length of the target region 3, thus the prompt module 109 may determine that the face region exceeds the target region, and then prompt the user to increase the distance between the user and the electronic device 1 or enlarge the target region 3. For example, if the user determines to enlarge the target region 3, the user may input parameter values of the target region 3, and then the setting module 100 resets the target region 3 according to the input parameter values.

In some embodiments, the prompt module 109 outputs different kinds of prompt information (e.g., the third prompt information as mentioned above) using the speaker 15 of the electronic device 1. Different kinds of prompt information may correspond to different prerecorded audio data. For example, the third prompt information may be “please move the electronic device away” or “please select whether to enlarge the target region.”

In step S24, the recognition module 102 waits for a predetermined time interval, and then the procedure returns to step S14, the recognition module 102 goes on recognizing the face region or a new face region after the user moves the electronic device 1 or enlarges the target region. The predetermined time interval may be preset or modified using the setting module 100.

In step S26, the determination module 108 determines whether the face region is located in the target region by comparing the coordinates of the four vertexes of the face region and the coordinates of the four vertexes of the target region. A detailed example is provided below.

If the face region is not located in the target region, the procedure goes to step S28. Otherwise, if the face region is located in the target region, the procedure goes to step S30.

In step S28, the prompt module 109 outputs second prompt information to prompt that the electronic device 1 needs to be moved, and then the procedure goes to step S24. That is, the recognition module 102 will wait for the predetermined time interval, and then goes on to recognize the face region (in step S14) displayed on the image preview interface, after the user moves the electronic device 1 according to the second prompt information or the target region is enlarged.

In step S30, the prompt module 109 outputs first prompt information to prompt that a self portrait is ready to be captured, and then the procedure ends.

For example, as shown in FIG. 3C, when a left abscissa (e.g., X3) of the face region 4 is less than a left abscissa (e.g., X1) of the target region 3, the determination module 108 determines that the user is left off a center of the target region 3, and the prompt module 109 outputs a prompt that the electronic device 1 needs to be moved leftwards.

When a right abscissa (e.g., X4) of the face region 4 is more than a right abscissa (e.g., X2) of the target region 3, the determination module 108 determines that the user is right off the center of the target region 3, and the prompt module 109 outputs a prompt that the electronic device 1 needs to be moved rightwards.

When an upper ordinate (e.g., Y4) of the face region 4 is more than an upper ordinate (e.g., Y2) of the target region 3, the determination module 108 determines that the user is up off the center of the target region 3, and the prompt module 109 outputs a prompt that the electronic device 1 needs to be moved upwards.

When a lower ordinate (e.g., Y3) of the face region 4 is less than a lower ordinate (e.g., Y1) of the target region 3, the determination module 108 determines that the user is down off the center of the target region 3, and the prompt module 109 outputs a prompt that the electronic device 1 needs to be moved downwards.

If more than one situations as mentioned above are occurred, the prompt module 109 may integrate more than one kind of prompt information when the user is off the center of the target region 3 in more than one direction, and output the integrated prompt information. For example, when the user is upper-left off the center of the target region 3, the prompt module 109 may output a prompt that states: “please move the electronic device towards left and down.”

As shown in FIG. 3D, when all the four vertexes of the face regions 4 are located in a range of the target region 3, the determination module 108 determines that the face region 4 is located in the target region 3, and the prompt module 109 outputs a prompt that the self portrait is ready to be captured.

In other embodiments, when there are a plurality of face regions recognized on the image preview interface, the above method may be implemented for a plurality of times to determine whether each of the face regions are in the target region, for the purpose of capturing a clear self portrait image.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented guiding method for taking a self portrait using an electronic device, the electronic device comprising a camera module, the method comprising:
constructing a coordinate system based on an image preview interface provided by the camera module;
presetting a length, a width and coordinates of a target region in the coordinate system;
recognizing a face region when the image preview interface is displayed;
determining a length, a width and coordinates of the face region;
determining whether the face region is located in the target region by comparing the coordinates of the face region and the coordinates of the target region, when the length of the face region is not more than the length of the target region and the width of the face region is not more than the length of the target region; and
outputting first prompt information to prompt that a self portrait is ready to be captured when the face region is located in the target region, or outputting second prompt information to prompt that the electronic device needs to be moved when the face region is not located in the target region.

2. The method according to claim 1, further comprising:
determining that the face region exceeds the target region when the length of the face region is more than the length of the target region or the width of the face region is more than the width of the target region; and
outputting third prompt information to prompt that a distance between a user and the electronic device needs to be increased or the target region needs to be enlarged.

3. The method according to claim 1, wherein the second prompt information:
prompts that the electronic device needs to be moved leftwards when a left abscissa of the face region is less than a left abscissa of the target region; or
prompts that the electronic device needs to be moved rightwards when a right abscissa of the face region is more than a right abscissa of the target region; or
prompts that the electronic device needs to be moved upwards when an upper ordinate of the face region is more than an upper ordinate of the target region; or
prompts that the electronic device needs to be moved downwards when a lower ordinate of the face region is less than a lower ordinate of the target region.

4. The method according to claim 1, wherein the first prompt information and the second prompt information are prerecorded audio information and outputted by a speaker of the electronic device.

5. The method according to claim 1, wherein the target region and the face region are represented using rectangles displayed on the image preview interface.

6. The method according to claim 1, further comprising:
integrating more than one kind of prompt information when the user is off a center of the target region in more than one direction; and
outputting the integrated prompt information.

7. An electronic device, comprising:
a camera module;
a storage device;
at least one processor; and
one or more modules that are stored in the storage device and are executed by the at least one processor, the one or more modules comprising:
a setting module that constructs a coordinate system based on an image preview interface provided by the camera module, and presets a length, a width and coordinates of a target region;
a recognition module that recognizes a face region when the image preview interface is displayed;
a preview module that determines a length, a width and coordinates of the face region;
a determination module that determines whether the face region is located in the target region by comparing the coordinates of the face region and the coordinates of the target region, when the length of the face region is not more than the length of the target region and the width of the face region is not more than the length of the target region; and
a prompt module that outputs first prompt information to prompt that a self portrait is ready to be captured when the face region is located in the target region, or outputs second prompt information to prompt that the electronic device needs to be moved when the face region is not located in the target region.

8. The electronic device according to claim 7, wherein the prompt module further determines that the face region exceeds the target region when the length of the face region is more than the length of the target region or the width of the face region is more than the width of the target region, and outputs third prompt information to prompt that a distance between a user and the electronic device needs to be increased or the target region needs to be enlarged.

9. The electronic device according to claim 7, wherein the prompt module:
prompts that the electronic device needs to be moved leftwards when a left abscissa of the face region is less than a left abscissa of the target region; or
prompts that the electronic device needs to be moved rightwards when a right abscissa of the face region is more than a right abscissa of the target region; or
prompts that the electronic device needs to be moved upwards when an upper ordinate of the face region is more than an upper ordinate of the target region; or
prompts that the electronic device needs to be moved downwards when a lower ordinate of the face region is less than a lower ordinate of the target region.

10. The electronic device according to claim 7, wherein the first prompt information and the second prompt information are prerecorded audio information, and the prompt module outputs the first prompt information or the second prompt information using a speaker of the electronic device.

11. The electronic device according to claim 7, wherein the target region and the face region are represented using rectangles displayed on the image preview interface.

12. The electronic device according to claim 7, wherein the prompt module further integrates more than one kind of prompt information when the user is off a center of the target region in more than one direction, and outputs the integrated prompt information.

13. A non-transitory storage medium having stored thereon instructions that, when executed by a processor of an electronic device, causes the electronic device to perform a guiding method for taking a self portrait using an electronic device, the electronic device comprising a camera module, the method comprising:
constructing a coordinate system based on an image preview interface provided by the camera module;
presetting a length, a width and coordinates of a target region in the coordinate system;
recognizing a face region when the image preview interface is displayed;
determining a length, a width and coordinates of the face region;
determining whether the face region is located in the target region by comparing the coordinates of the face region and the coordinates of the target region, when the length of the face region is not more than the length of the target region and the width of the face region is not more than the length of the target region; and
outputting first prompt information to prompt that a self portrait is ready to be captured when the face region is located in the target region, or outputting second prompt information to prompt that the electronic device needs to be moved when the face region is not located in the target region.

14. The non-transitory storage medium according to claim 13, wherein the method further comprises:
determining that the face region exceeds the target region when the length of the face region is more than the length of the target region or the width of the face region is more than the width of the target region; and
outputting third prompt information to prompt that a distance between a user and the electronic device needs to be increased or the target region needs to be enlarged.

15. The non-transitory storage medium according to claim 13, wherein the second prompt information:
prompts that the electronic device needs to be moved leftwards when a left abscissa of the face region is less than a left abscissa of the target region; or
prompts that the electronic device needs to be moved rightwards when a right abscissa of the face region is more than a right abscissa of the target region; or
prompts that the electronic device needs to be moved upwards when an upper ordinate of the face region is more than an upper ordinate of the target region; or
prompts that the electronic device needs to be moved downwards when a lower ordinate of the face region is less than a lower ordinate of the target region.

16. The non-transitory storage medium according to claim 13, wherein the first prompt information and the second prompt information are prerecorded audio information and outputted by a speaker of the electronic device.

17. The non-transitory storage medium according to claim 13, wherein the target region and the face region are represented using rectangles displayed on the image preview interface.

18. The non-transitory storage medium according to claim 13, wherein the method further comprises:
integrating more than one kind of prompt information when the user is off a center of the target region in more than one direction; and
outputting the integrated prompt information.
